(19) United States
(12) Patent Application Publication
(10) Pub. No.: US 2013/0329415 A1
(43) Pub. Date: Dec. 12, 2013

(54) LIGHT EMITTING MODULE

(71) Applicant: LEXTAR ELECTRONICS CORPORATION, Hsinchu (TW)

(72) Inventor: Yu-Ling Lin, Hsinchu City (TW)

(21) Appl. No.: 13/908,634

(22) Filed: Jun. 3, 2013

(30) Foreign Application Priority Data
Jun. 7, 2012 (TW) 101211003

(51) Int. Cl. F21V 14/00

(52) U.S. Cl. CPC F21V 14/00
USPC 362/227

(57) ABSTRACT

A light emitting module includes a substrate, two first LEDs (light emitting diode), two second LEDs (light emitting diode) and at least one first circular LED array. The substrate includes a first central line and a second central line. The first central line and the second central line are substantially perpendicularly crossed on the center of the substrate. The first LEDs are disposed oppositely on the first central line and spatially separated by the center of the substrate. The second LEDs are disposed oppositely on the second central line and spatially separated by the center of the substrate. The color temperature of the light emitted by the first LEDs is different from which by the second LEDs. The first circular LED array is disposed on the substrate.

### RELATED APPLICATIONS

This application claims priority to Taiwan Application Serial Number 101211003, filed Jun. 7, 2012, which is herein incorporated by reference.

### BACKGROUND

1. Technical Field

Embodiments of the present invention relate to a light emitting module, and more particularly relate to a light emitting module employing a light emitting diode.

2. Description of Related Art

In recent years, with the rising of environmental awareness, eco-friendly product has become the main trend in industry development. In order to achieve the purpose of the eco-friendly trend, a conventional tungsten lamp is replaced by a light emitting diode (LED) with low power consumption and high efficiency.

Currently, common LED lamps mainly include a LED lamp panel. For the LED lamp panel, a plurality of LED packages are arranged on a circuit substrate to emit light.

However, since in most of the current LED lamp panels, the LEDs are installed in a random distribution manner, if LEDs with different colors are installed, it cannot provide an excellent color mixing effect.

### SUMMARY

In view of the above, a technical aspect of the present invention provides a light emitting module in which light emitting diodes (LED) with different colors are arranged in accordance to a specific order to improve the color mixing effect.

According to an embodiment of the present invention, a light emitting module includes a substrate, two first LEDs (light emitting diode), two second LEDs (light emitting diode) and at least one first circular LED array. The substrate includes a first central line and a second central line. The first central line and the second central line are substantially perpendicularly crossed on the center of the substrate. The first LEDs are disposed oppositely on the first central line of the substrate and spatially separated by the center of the substrate. The second LEDs are disposed oppositely on the second central line of the substrate and spatially separated by the center of the substrate. The color temperature of the light emitted by the first LEDs is different from which by the second LEDs. The first circular LED array is disposed on the substrate.

By the aforesaid embodiments, the first LEDs and the second LEDs are arranged on the substrate in a crisscross-like manner, and the first circular LED array is disposed on the substrate. Due to the first LEDs and second LEDs arranged in a crisscross-like manner and the first circular LED array disposed on the substrate, the color mixing effect of the light emitting module can be improved.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a top view of a light emitting module according to an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

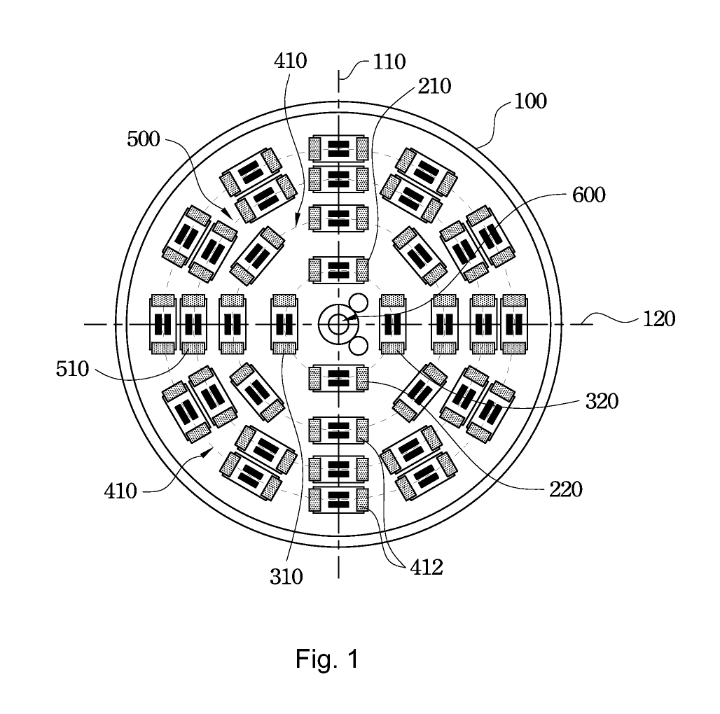

FIG. 1 is a top view of a light emitting module according to an embodiment of the present invention. As shown in the figure, the light emitting module according to this embodiment includes a substrate 100, two first LEDs (light emitting diode) 210 and 220, two second LEDs 310 and 320, and at least one first circular LED array 410. The substrate 100 has a first central line 110 and a second central line 120. The first central line 110 and the second central line 120 are substantially perpendicularly crossed on the center of the substrate 100. The first LEDs 210 and 220 are disposed oppositely on the first central line 110 of the substrate 100 and spatially separated by the center of the substrate 100. The second LEDs 310 and 320 are disposed oppositely on the second central line 120 of the substrate 100 and spatially separated by the center of the substrate 100. The color temperature of the light emitted by the first LEDs 210 and 220 is different from which by the second LEDs 310 and 320. The first circular LED array 410 is disposed on the substrate 100.

The aforesaid embodiment of the present invention may dispose the first LEDs 210 and 220 and the second LEDs 310 and 320 respectively on the first central line 110 and the second central line 120 of the substrate 100, so that the first LEDs 210 and 220 and the second LEDs 310 and 320 are arranged in a crisscross-like manner. Furthermore, in the aforesaid embodiment, a first circular LED array 410 may be further disposed on the substrate 100.

It is understood that the term “substantially” stated throughout this specification is used for describing any feature, which can be modified slightly, but the essence of the feature will not be changed by the slight modification. For example, in addition to the meaning that the first central line 110 and the second central line 120 are exactly perpendicularly crossed on the center of the substrate 100, “the first central line 110 and the second central line 120 are substantially perpendicularly crossed on the center of the substrate 100” also includes the meaning that the first central line 110 and the second central line 120 are slightly un-perpendicular to each other as long as the first LEDs 210, 220 and the second LEDs 310, 320 disposed on the first central line 110 and the second central line 120 are arranged in a crisscross-like manner.

In some embodiments, the first circular LED array 410 surrounds the first LEDs 210, 220 and the second LEDs 310, 320. In particular, the first circular LED array 410 may surround the first LEDs 210, 220 and the second LEDs 310, 320 arranged in the crisscross-like manner.

In some embodiments, the light emitting module may further include at least one second circular LED array 500. The second circular LED array 500 surrounds the first circular LED array 410. In particular, the second circular LED array 500 surrounds the outer side of the first circular LED array 410, and the first LEDs 210, 220 and the second LEDs 310, 320 are arranged in the crisscross-like manner at the inner side of first circular LED array 410.

In some embodiments, the light emitting module may further include another first circular LED array 410 disposed at the outermost circle of the substrate 100, and the second circular LED array 500 is sandwiched between the first circular LED array 410 arranged at the inner circle and the first circular LED array 410 arranged at the outer circle.

In some embodiments, the first circular LED array 410 arranged at the inner circle and the first circular LED array 410 arranged at the outer circle both include a plurality of third LEDs 412. Each second circular LED array 500 includes a plurality of fourth LEDs 510, wherein the color temperature of the light emitted by the third LEDs 412 is different from which by the fourth LEDs 510.

In other words, the second circular LED array 500 may be sandwiched between the first circular LED array 410 arranged at the inner circle and the first circular LED array 410 arranged at the outer circle, and the color temperature of the light emitted by the second circular LED array 500 is different from which by the first circular LED array 410 arranged at the inner circle and the first circular LED array 410 arranged at the outer circle.

It is understood that the color temperature refers the temperature of an ideal black body radiator that radiates light of comparable hue to that of the light emitting. For example, when the color of the light emitted by a light emitting is the same as the color of the light emitted by the black body at a temperature of 2800 K, the color temperature of the light emitted by the light emitting is 2800 K.

In some embodiments, the first circular LED array 410 closer to the center of the substrate 100 includes eight third LEDs 412, and the first circular LED array 410 farther from the center of the substrate 100 includes twelve third LEDs 412, and the second circular LED array 500 includes twelve fourth LEDs 510. It is noted that the number of the third LEDs 412 and the fourth LEDs 510 described above is only illustrative, and thus not intended to limit the present invention.

In some embodiments, the third LEDs 412 are arranged with an equal distance between each two thereof, and the fourth LEDs 510 are also arranged in the same manner. In other words, the distance between adjacent two of third LEDs 412 is the same, and the distance between adjacent two of the fourth LEDs 510 is also the same. Therefore, the color of the light emitted by the first circular LED arrays 410 and which by the second circular LED array 500 can be mixed uniformly.

In some embodiments, the distance between the first circular LED array 410 arranged at the inner circle and the second circular LED array 500 is approximately between 6 to 20 mm. In some embodiments, the distance between the first circular LED array 410 arranged at the outer circle and the second circular LED array 500 is approximately between 6 to 20 mm.

In some embodiments, the color temperature of the light emitted by the third LEDs 412 is equal to which by the first LEDs 210 and 220, and the color temperature of the light emitted by the fourth LEDs 510 is equal to which by the second LEDs 310 and 320.

In some embodiments, the first LEDs 210 and 220 on the first central line 110 are symmetrical relative to the center of the substrate 100. The second LEDs 310 and 320 on the second central line 120 are also symmetrical relative to the center of the substrate 100. In some embodiments, the distance between the first LEDs 210 and 220 is equal to which between the second LEDs 310 and 320, thereby forming a symmetrical crisscross shape.

In some embodiments, the light emitting module may further include a center hole 600 arranged at the center of the substrate 100.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light emitting module, comprising:
a substrate having a first central line and a second central line, wherein the first central line and the second central line are substantially perpendicularly crossed on the center of the substrate;
two first LEDs (light emitting diode) disposed oppositely on the first central line of the substrate and spatially separated by the center of the substrate;
two second LEDs disposed oppositely on the second central line of the substrate and spatially separated by the center of the substrate, wherein the color temperature of the light emitted by the first LEDs is different from which by the second LEDs; and
at least one first circular LED array disposed on the substrate.

2. The light emitting module of claim 1, wherein the first circular LED array surrounds the first LEDs and the second LEDs.

3. The light emitting module of claim 2, further comprising:
at least one second circular LED array surrounding the first circular LED array.

4. The light emitting module of claim 3, wherein the number of the first circular LED arrays is two, and the second circular LED array is sandwiched between the first circular LED arrays.

5. The light emitting module of claim 4, wherein each of the first circular LED arrays comprises a plurality of third LEDs, and each of the second circular LED arrays comprises a plurality of fourth LEDs, wherein the color temperature of the light emitted by the third LEDs is different from which by the fourth LEDs.

6. The light emitting module of claim 5, wherein the first circular LED array closer to the center of the substrate comprises eight of the third LEDs, the first circular LED array farther from the center of the substrate comprises twelve of the third LEDs, and the second circular LED array comprises twelve of the fourth LEDs.

7. The light emitting module of claim 5, wherein the third LEDs are arranged with an equal distance between each two thereof, and the fourth LEDs are also arranged in the same manner.

8. The light emitting module of claim 5, wherein the color temperature of the light emitted by the third LEDs is equal to which by the first LEDs, and the color temperature of the light emitted by the fourth LEDs is equal to which by the second LEDs.

9. The light emitting module of claim 1, wherein the first LEDs on the first central line are symmetrical relative to the center of the substrate, and the second LEDs on the second central line are also symmetrical relative to the center of the substrate.

10. The light emitting module of claim 1, further comprising a center hole disposed at the center of the substrate.
